(19) United States
(12) Patent Application Publication
(10) Pub. No.: US 2024/0394018 A1
(43) Pub. Date: Nov. 28, 2024

(54) Dot Product Pipeline for Floating Point and Shared Exponent Floating Point Data Types

(71) Applicant: Microsoft Technology Licensing, LLC, Redmond, WA (US)

(72) Inventor: Mathew Kent HALL, Redmond, WA (US)

(21) Appl. No.: 18/321,646

(22) Filed: May 22, 2023

(51) Int. Cl. G06F 7/544; G06F 7/485; G06F 7/487

(52) U.S. Cl. CPC G06F 7/5443; G06F 7/485; G06F 7/4876

(57) ABSTRACT

Embodiments of the present disclosure include systems and methods for providing a dot product pipeline for floating point and shared exponent floating point data types. During a first mode of operation, a method uses a first subset of the plurality of hardware components of the dot product hardware pipeline to perform a first dot product operation on a first plurality of floating point numbers and a second plurality of floating point numbers. During a second mode of operation, the method uses a second subset of the plurality of hardware components of the dot product hardware pipeline to perform a second dot product operation on a third plurality of floating point numbers and a fourth plurality of floating point numbers. A third subset of the plurality of hardware components are shared between the first subset of the plurality of hardware components and the second subset of the plurality of hardware components.

### BACKGROUND

The present disclosure relates to computing hardware. More particularly, the present disclosure relates to dot product pipeline architectures.

A dot product pipeline is generally configured to perform dot product operations. For example, a dot product pipeline can be configured to receive two sets of floating point numbers (e.g., two vectors of floating point numbers) as inputs, multiply floating point numbers in one of the sets of floating point numbers with corresponding floating point numbers in the other set of floating point numbers, and add the products together to generate a scalar output that represents a dot product of the two sets of floating point numbers. Dot product pipelines are utilized in many applications including central processing units (CPUs), graphics processing units (GPUS), hardware accelerators, etc.

### BRIEF DESCRIPTION OF THE DRAWINGS

Various embodiments of the present disclosure are illustrated by way of example and not limitation in the figures of the accompanying drawings.

FIG. 1 illustrates a dot product hardware pipeline operating in a first mode of operation according to some embodiments.

FIG. 2 illustrates the dot product hardware pipeline illustrated in FIG. 1 operating in a second mode of operation according to some embodiments.

FIG. 3 illustrates an example structure of a standard floating point data type according to some embodiments.

FIG. 4 illustrates an example structure of a shared exponent floating point data type according to some embodiments.

FIG. 5 illustrates an example architecture of the dot product hardware pipeline illustrated in FIG. 1 according to some embodiments.

FIG. 6 illustrates an example architecture of the dot product hardware pipeline illustrated in FIG. 2 according to some embodiments.

FIG. 7 illustrates a process for performing dot product operations using different modes of a dot product hardware pipeline according to some embodiments.

FIG. 8 illustrates an artificial intelligence (AI) accelerator according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for providing a dot product pipeline for floating point and shared exponent floating point data types. In some embodiments, a dot product pipeline is configured to operate in a first mode of operation. In the first mode of operation, the dot product pipeline may receive two sets of floating point numbers as inputs. The two sets of floating point numbers are structured using a standard floating point data type. Next, the dot product pipeline performs a first dot product operation on the two sets of inputs to produce a first floating point scalar output. The dot product pipeline can be configured to operate in a second mode of operation. In the second mode of operation, the dot product pipeline may receive another two sets of floating point numbers as inputs. These two sets of floating point numbers are structured using a shared exponent floating point data type. Then, the dot product pipeline performs a second dot product operation on the two sets of inputs to produce a second floating point scalar output. The first mode of operation and the second mode of operation share a set of hardware components in the dot product pipeline. That is, although different sets of hardware components of the dot product pipeline can be utilized when operating in each of the first mode of operation and the second mode of operation, a common set of hardware components of the dot product pipeline are used in each of the first mode of operation and the second mode of operation.

The techniques described in the present application provide a number of benefits and advantages over conventional dot product pipelines. For instance, reusing hardware components in a dot product pipeline for different modes of operation that support different data types reduces the amount of area used in implementing the dot product pipeline in an integrated circuit. This allows more dot product pipelines and/or other components to fit on the integrated circuit. Conventional methods that employ separate dot product pipelines to support different data types use more area in an integrated circuit.

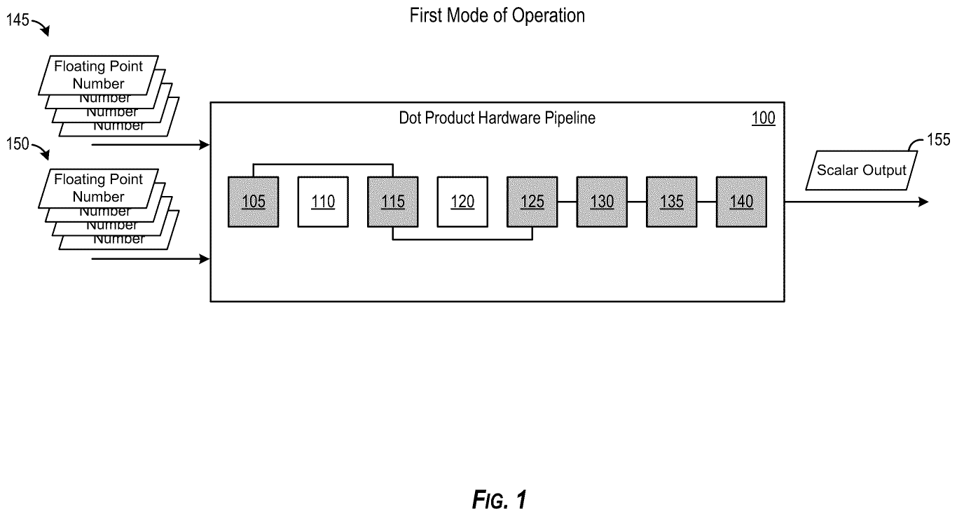

FIG. 1 illustrates a dot product hardware pipeline 100 operating in a first mode of operation according to some embodiments. As shown, dot product hardware pipeline 100 includes hardware components 105-140. For this example, dot product hardware pipeline 100 receives a first set of floating point numbers 145 and a second set of floating point numbers 150 as inputs when dot product hardware pipeline 100 is operating in the first mode of operation. Dot product hardware pipeline 100 then performs a dot product operation on the first and second sets of floating point numbers 145 and 150. As indicated by gray shading in FIG. 1, dot product hardware pipeline 100 uses hardware components 105, 115, and 125-140 to perform the dot product operation when operating in the first mode of operation. Based on the dot product operation, dot product hardware pipeline 100 generates scalar output 155. Scalar output 155 is a floating point number that represents the dot product between the first set of floating point numbers 145 and the second set of floating point numbers 150.

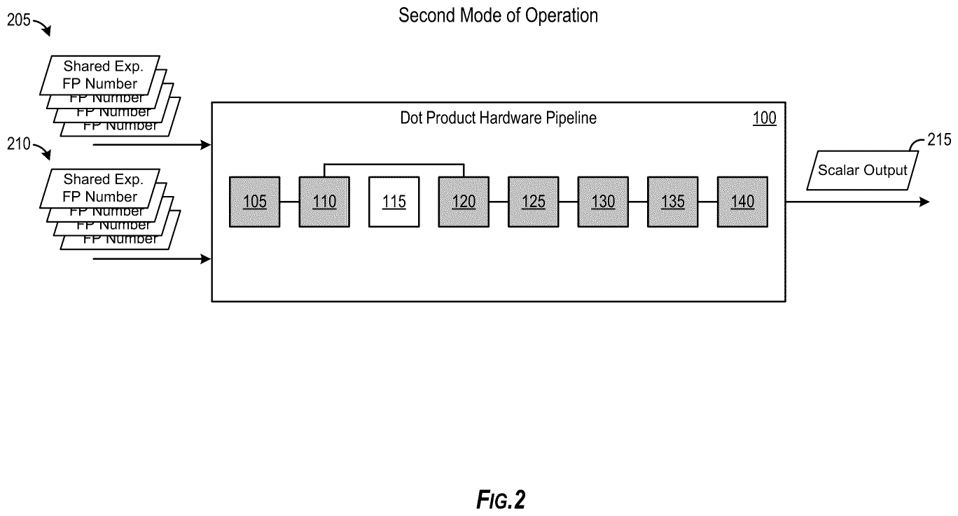

FIG. 2 illustrates dot product hardware pipeline 100 operating in a second mode of operation according to some embodiments. As illustrated in FIG. 2, dot product hardware pipeline 100 includes the same hardware components 105-140 as those shown in FIG. 1. In this example, dot product hardware pipeline 100 receives a first set of shared exponent floating point numbers 205 and a second set of shared exponent floating point numbers 210 as inputs when dot product hardware pipeline 100 is operating in the second mode of operation. Next, dot product hardware pipeline 100 performs a dot product operation on the first and second sets of shared exponent floating point numbers 205 and 210. As indicated by gray shading in FIG. 2, dot product hardware pipeline 100 uses hardware components 105, 110, and 120-140 to perform the dot product operation when operating in the second mode of operation. Based on the dot product operation, dot product hardware pipeline 100 generates scalar output 215. Scalar output 215 is a floating point number that represents the dot product between the first set of shared exponent floating point numbers 205 and the second set of shared exponent floating point numbers 210.

FIGS. 1 and 2 illustrate different modes of operation of a dot product hardware pipeline. For instance, the dot product hardware pipeline is configured to handle different floating point data types in the different modes of operation. Specifically, in the first mode of operation, the dot product hardware pipeline is configured to receive sets of floating point numbers structured in a standard floating point data type while, in the second mode of operation, the dot product hardware pipeline is configured to receive sets of floating point numbers structured in a shared exponent floating point data type.

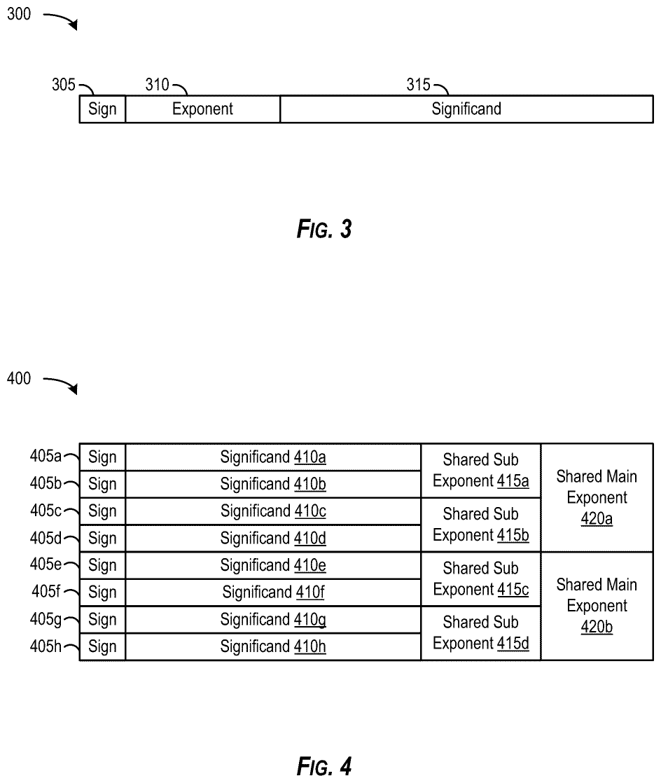

FIG. 3 illustrates an example structure of a standard floating point data type 300 according to some embodiments. In some embodiments, each floating point number in the first and second sets of floating point numbers 145 and 150 is structured according to floating point data type 300. As depicted in FIG. 3, floating point data type 300 includes three components: sign 305, exponent 310, and significand 315. Sign 305 represents the sign value of a floating point number, exponent 310 represents the exponent value of the floating point number, and significand 315 represents the significand value of the floating point number.

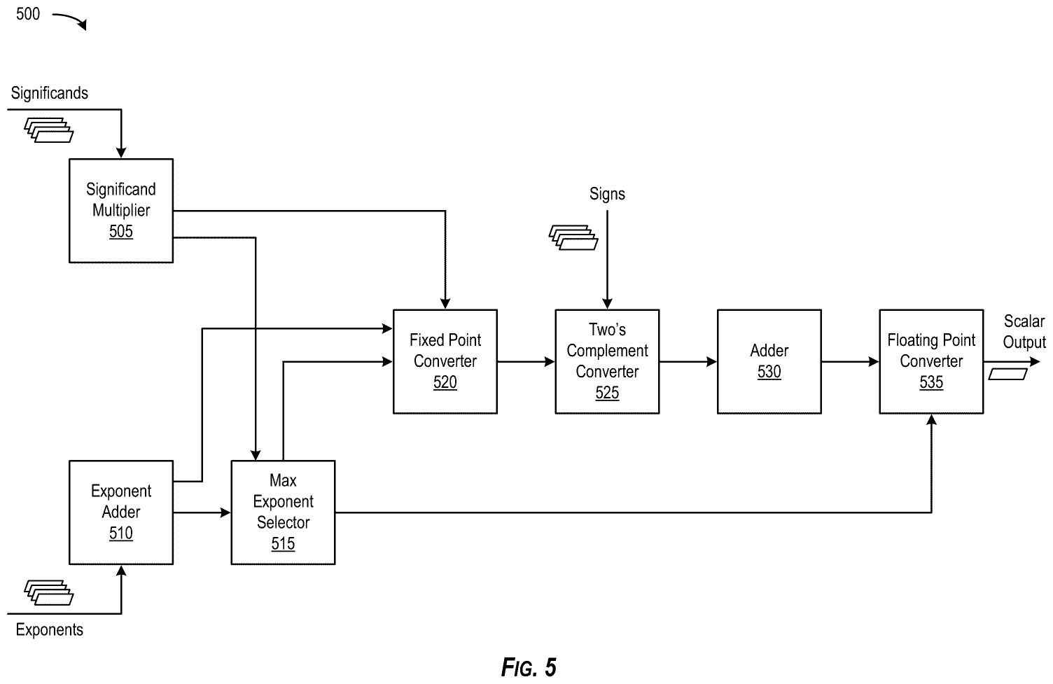

FIG. 4 illustrates an example structure of a shared exponent floating point data type 400 according to some embodiments. In some embodiments, each of the first set of floating point numbers 205 and the second set of floating point numbers 210 is structured according to shared exponent floating point data type 400. In this example shared exponent floating point data type 400 is used to represent eight floating point numbers. As shown, shared exponent floating point data type 400 includes signs 405a-h, significands 410a-h, shared sub exponents 415a-d, and shared main exponents 420a and 420b. Each of the signs 405a-h is the sign value of a respective floating point number. Each of the corresponding significands 410a-h is the significand value of the respective floating point number. Here, shared exponent floating point data type 400 employs two levels of shared exponent values to represent an exponent of a floating point number. Each of the shared sub exponents 415a-d is an exponent value that is subtracted from shared main exponent 420, which is another exponent value, to determine the actual exponent value for a floating point number. For instance, to determine the actual exponent value for significand 410a, shared sub exponent 415a is subtracted from shared main exponent 420a. As another example, to determine the actual exponent value for significand 410h, shared sub exponent 415d is subtracted from shared main exponent 420b. As shown in FIG. 4, significands 410a and 410b share the same shared sub exponent 415a, significands 410c and 410d share the same sub exponent 415b, significands 410e and 410f share the same sub exponent 415c, and significands 410g and 410h share the same sub exponent 415d. Significands 410a-d share shared main exponent 420a while significands 410e-h share shared main exponent 420b.

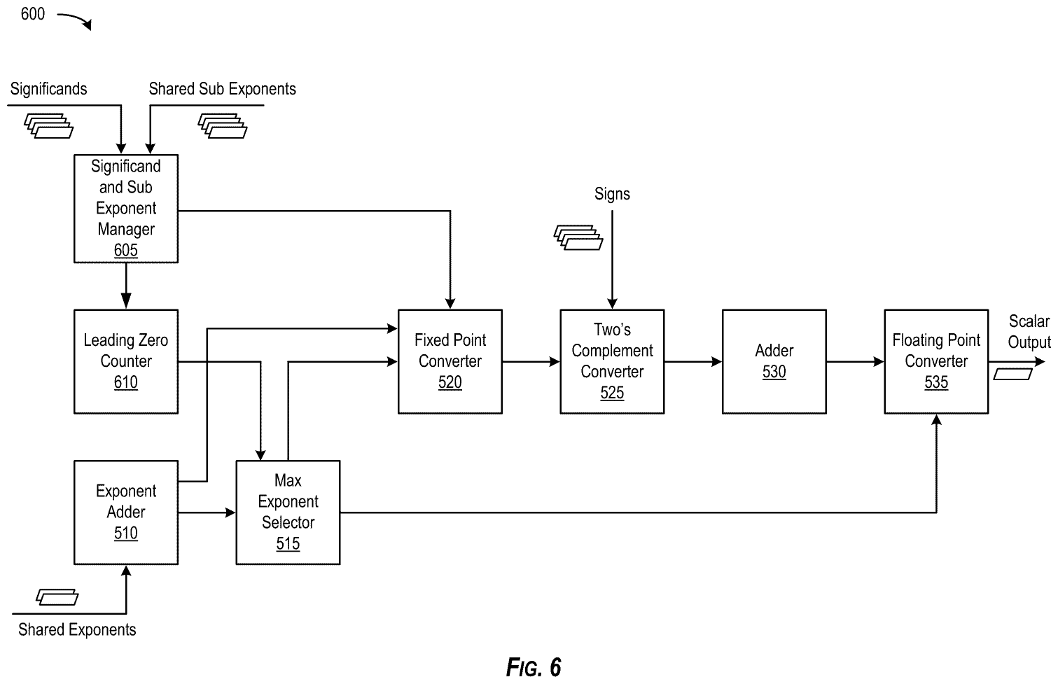

FIG. 5 illustrates an example architecture 500 of dot product hardware pipeline 100 according to some embodiments. In particular, architecture 500 is used to implement dot product hardware pipeline 100 when it is operating in the first mode of operation. As illustrated, architecture 500 includes significand multiplier 505, exponent adder 510, max exponent selector 515, fixed point converter 520, two's complement converter 525, adder 530, and floating point converter 535. In some embodiments, each of the significand multiplier 505, exponent adder 510, max exponent selector 515, fixed point converter 520, two's complement converter 525, adder 530, and floating point converter 535 can be implemented as a circuit.

Significand multiplier 505 is configured to multiply significand values. For example, significand multiplier 505 receives the significand values of two sets of floating point numbers that architecture 500 receives as inputs (e.g., significands of the first set of floating point numbers 145 and significands of the second set of floating point numbers 150). Then, significand multiplier 505 performs a Hadamard product operation between the two sets of significand values. For instance, significand multiplier 505 may multiply the significand of the first floating point number in the first set of floating point numbers with the significand of the first number in the second set of floating point numbers, multiply the significand of the second floating point number in the first set of floating point numbers with the significand of the second number in the second set of floating point numbers, and so on and so forth. After performing the Hadamard product operation, significand multiplier 505 sends the products to fixed point converter 520 for further processing. In addition, significand multiplier 505 sends max exponent selector 515 the most significant bit of each product.

Exponent adder 510 is responsible for adding exponent values. For example, exponent adder 510 receives the exponent values of the two sets of floating point numbers that architecture 500 receives as inputs. Next, exponent adder 510 adds the exponent value of each floating point number in the first set of floating point numbers with the exponent value of the corresponding floating point number in the second set of floating point numbers. For instance, exponent adder 510 can add the exponent of the first floating point number in the first set of floating point numbers with the exponent of the first number in the second set of floating point numbers, add the exponent of the second floating point number in the first set of floating point numbers with the exponent of the second number in the second set of floating point numbers, and so on and so forth. Once the exponents are added up, exponent adder 510 sends the sums to max exponent selector 515. Exponent adder 510 also sends the sums to fixed point converter 520.

Max exponent selector 515 handles the selection of exponent values. For example, when max exponent selector 515 receives the sums of the exponent values from exponent adder 510 and the most significant bits of the products from significant multiplier 505, max exponent selector 515 adds the most significant bit from each product and its corresponding sum of exponent values. For instance, max exponent selector 515 can add (1) the most significant bit of the product between the significands of the first floating point number in the first set of floating point numbers and the first number in the second set of floating point numbers and (2) the sum of the exponent values of the first floating point number in the first set of floating point numbers and the first number in the second set of floating point numbers. From these adjusted exponent value sums, max exponent selector 515 selects the highest exponent value and sends the selected value to fixed point converter 520.

Fixed point converter 520 is designed to convert the values received from significand multiplier 505 into fixed point numbers. In response to receiving the products from significand multiplier 505, the sums of exponent values from exponent adder 510, and the selected exponent value from max exponent selector 515, fixed point converter 520 converts the products that it receives from significand manager 505 to fixed point numbers. In particular, for each product received from significand manager 505, fixed point converter 520 subtracts the sum of exponent values associated with the product from the selected exponent value and then performs right shifts on the product based on the difference. For example, if the difference between the sum of exponent values associated with the product and the selected exponent value is two (2), fixed point converter 520 performs two right shift operations on the product. This way, the exponent values of the converted product values are aligned with each other (e.g., the product values each has the same exponent value). When fixed point converter 520 finishes converting the values to the fixed point numbers, fixed point converter 520 sends them to two's complement converter 525 for further processing.

Two's complement converter 525 is tasked with converting the fixed point numbers received from fixed point converter 520 into a two's complement representation. As depicted in FIG. 5, two's complement converter 525 receives the sign values of the two sets of floating point numbers that architecture 500 receives as inputs. Two's complement converter 525 converts each of the fixed point numbers to a two's complement representation based on the sign values of the corresponding significands used to determine the fixed point number (e.g., the significands used to generate the product that was converted to the fixed floating point number). Two's complement converter 525 then sends the two's complement numbers to adder 530.

Adder 530 is configured to add together numbers represented in two's complement. For instance, when adder 530 receives the two's complement numbers from two's complement converter 525, adder 530 adds those values together to produce a sum of the two's complement values. Adder 530 sends the sum to floating point converter 535.

Floating point converter 535 handles the conversion of two's complement numbers to floating point numbers. For example, floating point converter 535 may receive from adder 530 a sum value that is represented in two's complement. In response, floating point converter 535 converts the value from a two's complement representation to a floating point representation. Floating point converter 535 then outputs the floating point representation of the value, which is a scalar value that represents the dot product between the first set of floating point numbers and the second set of floating point numbers.

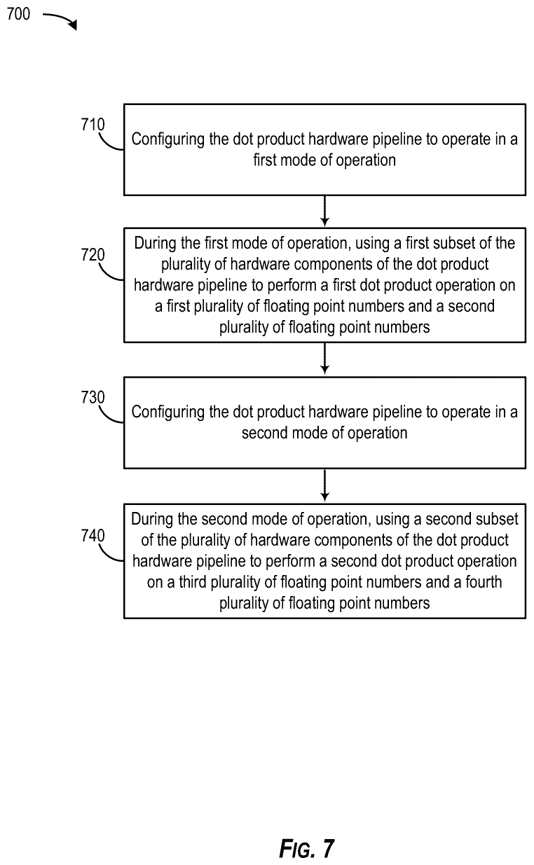

FIG. 6 illustrates an example architecture 600 of dot product hardware pipeline 100 according to some embodiments. In particular, architecture 500 is used to implement dot product hardware pipeline 100 when it is operating in the second mode of operation. Architecture 600 includes significand and sub exponent manager 605, leading zero counter 610, exponent adder 510, max exponent selector 515, fixed point converter 520, two's complement converter 525, adder 530, and floating point converter 535. As shown, architecture 600 of dot product hardware pipeline 100 shares some of the same components as architecture 500 of dot product hardware pipeline 100 (e.g., exponent adder 510, max exponent selector 515, fixed point converter 520, two's complement converter 525, adder 530, and floating point converter 535) and also includes different components that are not included in architecture 500 (e.g., significand and sub exponent manager 605 and leading zero counter 610). In some embodiments, each of the significand and sub exponent manager 605, leading zero counter 610, exponent adder 510, max exponent selector 515, fixed point converter 520, two's complement converter 525, adder 530, and floating point converter 535 can be implemented as a circuit.

Significand and sub exponent manager 605 is responsible for processing significands and shared sub exponents of floating point numbers. For instance, significand and sub exponent manager 605 receives the significand values and the shared sub exponent values of two sets of floating point numbers that architecture 600 receives as inputs (e.g., significands and shared sub exponents of the first set of floating point numbers 205 and significands and shared sub exponents of the second set of floating point numbers 210). Significand and sub exponent manager 605 then performs a Hadamard product operation between the two sets of significand values. For example, significand and sub exponent manager 605 can multiply the significand of the first floating point number in the first set of floating point numbers with the significand of the first number in the second set of floating point numbers, multiply the significand of the second floating point number in the first set of floating point numbers with the significand of the second number in the second set of floating point numbers, and so on and so forth.

Once significand and sub exponent manager 605 completes the Hadamard product operation, significand and sub exponent manager 605 adds together each pair of sub exponent values from the two sets of floating point numbers, performs a number of right shift operations on each of the corresponding products based on the sum of the sub exponent values, and adds the aligned corresponding products together. For instance, significand and sub exponent manager 605 may add together the first shared sub exponent of the first set of floating point numbers (e.g., shared sub exponent 415a of the first set of floating point numbers) and the first shared sub exponent of the second set of floating point numbers (e.g., shared sub exponent 415a of the second set of floating point numbers). If, for example, the sum is two, significand and sub exponent manager 605 performs two right shift operations on the product between the significand of the first floating point number in the first set of floating point numbers and the significand of the first number in the second set of floating point numbers and two shift operations on the product between the significand of the second floating point number in the first set of floating point numbers and the significand of the second number in the second set of floating point numbers. Then, significand and sub exponent manager 605 adds the products together. Significand and sub exponent manager 605 performs the same operations for each remaining shared sub exponent value and their associated significands (e.g., shared sub exponent 415b and its associated significands 410c and 410d). In this manner, significand and sub manager 605 performs a partial reduction operation on the significands of the two sets of floating point numbers based on their shared sub exponents. After performing this partial reduction operation on the significands, significand and sub exponent manager 605 sends the product sums to fixed point converter 520 for further processing. Significand multiplier 505 also sends the product sums to leading zero counter 610.

Leading zero counter 610 is configured to count leading zeros in values received from significand and sub exponent manager 605. For instance, when leading zero counter 610 receives a product sum from significand and sub exponent manager 605, leading zero counter 610 counts the number of leading zeros in the product sum and sends the count to max exponent selector 515.

Exponent adder 510 handles the addition of exponent values. For example, exponent adder 510 receives the shared main exponent values (e.g., shared main exponents 420a and 420b) of the two sets of floating point numbers that architecture 600 receives as inputs. Exponent adder 510 then adds each pair of shared main exponent values from the first and second sets of floating point numbers. For instance, exponent adder 510 can add together the first shared main exponent of the first set of floating point numbers (e.g., shared main exponent 420a of the first set of floating point numbers) and the first shared main exponent of the second set of floating point numbers (e.g., shared main exponent 420a of the second set of floating point numbers). Next, exponent adder 510 sends the sums to max exponent selector 515 and fixed point converter 520.

Max exponent selector 515 is responsible for selecting exponent values. For instance, upon receiving the sums of the exponent values from exponent adder 510 and the counts of leading zeros from leading zero counter 610, max exponent selector 515 subtracts the count of zeros of each product from its corresponding sum of exponent values. Based on from these adjusted exponent value sums, max exponent selector 515 selects the highest exponent value and sends the selected value to fixed point converter 520.

Fixed point converter 520 handles the conversion of values received from significand and sub exponent manager 605 into fixed point numbers. In response to receiving the product sums from significand and sub exponent manager 605, the sums of shared main exponent values from exponent adder 510, and the selected exponent value from max exponent selector 515, fixed point converter 520 converts the product sums that it receives from significand and sub exponent manager 605 to fixed point numbers. Specifically, for each product sum received from significand and sub exponent manager 605, fixed point converter 520 subtracts the sum of shared main exponent values associated with the product sum from the selected exponent value and then performs right shifts on the product based on the difference. For instance, if the difference between the sum of shared main exponent values associated with the product sum and the selected exponent value is one (1), fixed point converter 520 performs one right shift operation on the product sum. In this fashion, the exponent values of the converted product sum values are aligned with each other (e.g., the product sum values each has the same exponent value). After converting the product sums to the fixed point numbers, fixed point converter 520 sends them to two's complement converter 525 for further processing.

Two's complement converter 525 is configured to convert the fixed point numbers received from fixed point converter 520 into a two's complement representation. As shown in FIG. 6, two's complement converter 525 receives the sign values of the two sets of floating point numbers that architecture 600 receives as inputs. Two's complement converter 525 converts each of the fixed point numbers to a two's complement representation based on the sign values of the corresponding significands used to determine the fixed point number (e.g., the significands used to generate the product sum that was converted to the fixed floating point number). Then, two's complement converter 525 sends the two's complement numbers to adder 530.

Adder 530 is responsible for adding together numbers represented in two's complement. For instance, when adder 530 receives the two's complement numbers from two's complement converter 525, adder 530 adds those values together to produce a sum of the two's complement values. Adder 530 sends the sum to floating point converter 535.

Floating point converter 535 handles the conversion of two's complement numbers to floating point numbers. For instance, floating point converter 535 may receive from adder 530 a sum value that is represented in two's complement. In response, floating point converter 535 converts the value from a two's complement representation to a floating point representation. Next, floating point converter 535 outputs the floating point representation of the value. The floating point value is a scalar value that represents the dot product between the first set of floating point numbers and the second set of floating point numbers.

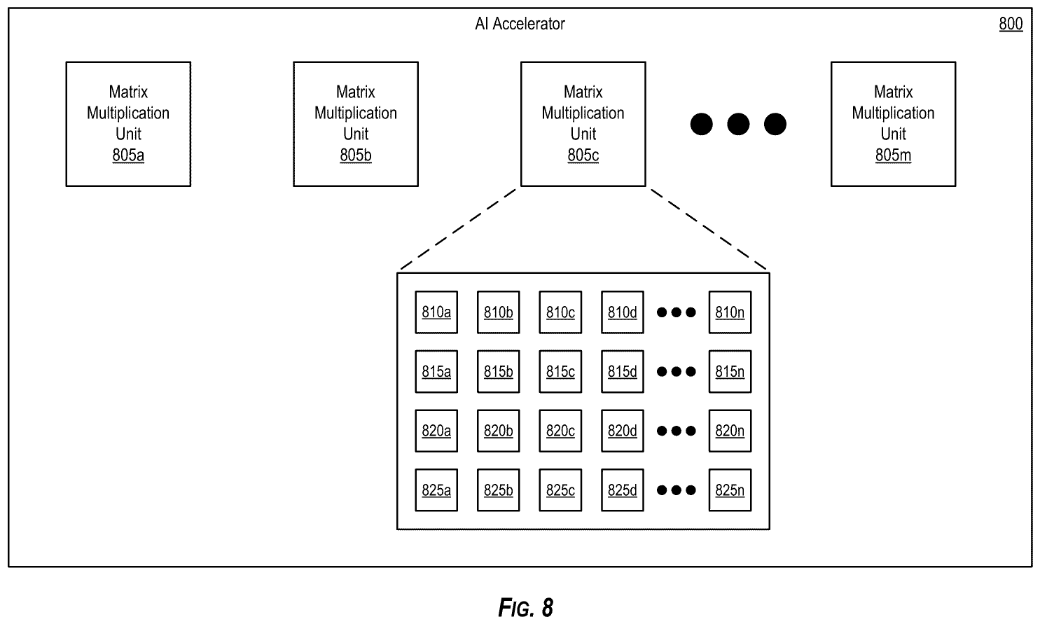

FIG. 7 illustrates a process 700 for performing dot product operations using different modes of a dot product hardware pipeline according to some embodiments. In some embodiments, dot product hardware pipeline 100 performs process 700. Process 700 starts by configuring, at 710, the dot product hardware pipeline to operate in a first mode of operation. Referring to FIG. 1 as an example, dot product hardware pipeline 100 may be configured to operate in a first mode of operation.

During the first mode of operation, process 700, at 720, uses a first subset of the plurality of hardware components of the dot product hardware pipeline to perform a first dot product operation on a first plurality of floating point numbers and a second plurality of floating point numbers. Referring to FIG. 1 as an example, hardware components 105, 115, and 125-140 of dot product hardware pipeline 100 can be used to perform a first dot produce operation on the first set of floating point numbers 145 and the second set of floating point numbers 150.

Next, process 700 configures, at 730, the dot product hardware pipeline to operate in a second mode of operation. Referring to FIG. 2 as an example, dot product hardware pipeline 100 can be configured to operate in a second mode of operation.

During the second mode of operation, process 700, at 740, uses a second subset of the plurality of hardware components of the dot product hardware pipeline to perform a second dot product operation on a third plurality of floating point numbers and a fourth plurality of floating point numbers. The third plurality of floating point numbers are extracted from a first instance of a shared exponent floating point data type. The fourth plurality of floating point numbers are extracted from a second instance of the shared exponent floating point data type. Referring to FIG. 2 as an example, hardware components 105, 110, and 120-140 of dot product hardware pipeline 100 can be used to perform a second dot produce operation on the first set of shared exponent floating point numbers 205 and the second set of shared exponent floating point numbers 210.

A third subset of the plurality of hardware components are shared between the first subset of the plurality of hardware components and the second subset of the plurality of hardware components. Referring to FIGS. 1 and 2 as an example, hardware components 105, 115, and 125-140 are the first subset of the hardware components of dot product hardware pipeline 100 used in the first mode of operation. Hardware components 105, 110, and 120-140 are the second subset of the hardware components of dot product hardware pipeline 100 used in the second mode of operation. In this example, hardware components 105 and 125-140 are the hardware components shared between the first and second subsets of the hardware components of dot product hardware pipeline 100.

FIG. 8 illustrates an artificial intelligence (AI) accelerator according to some embodiments. In some cases, AI accelerator 800 may be used for machine learning workloads (e.g., training machine learning models, using machine learning models for inference, etc.). As such, AI accelerator 800 can support any number of machine learning data types. For example, AI accelerator 800 may support floating point data types as well as shared exponent floating point data types (e.g., floating data types where multiple floating point values are stored together, share a common exponent value, and each has its own separate mantissa value).

As shown, AI accelerator 800 includes matrix multiplication units 805a-m. Each of the matrix multiplication units 805a-m is configured to perform multiplication operations on matrices. As depicted in FIG. 8, matrix multiplication unit 805c includes dot product pipelines 810a-n, 815a-n, 820a-n, and 825a-n. Here, each of the dot product pipelines 810a-n, 815a-n, 820a-n, and 825a-n is implemented by dot product hardware pipeline 100. In this example, each of the other matrix multiplication units 805a-m can be implemented in the same or similar manner as matrix multiplication unit 805c.

### Further Example Embodiments

In various embodiments, the present disclosure includes systems, methods, and apparatuses for providing a dot product pipeline for floating point and shared exponent floating point data types. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in some embodiments, the techniques described herein relate to a method executable by a dot product hardware pipeline including a plurality of hardware components, the method including: configuring the dot product hardware pipeline to operate in a first mode of operation: during the first mode of operation, using a first subset of the plurality of hardware components of the dot product hardware pipeline to perform a first dot product operation on a first plurality of floating point numbers and a second plurality of floating point numbers: configuring the dot product hardware pipeline to operate in a second mode of operation; and during the second mode of operation, using a second subset of the plurality of hardware components of the dot product hardware pipeline to perform a second dot product operation on a third plurality of floating point numbers and a fourth plurality of floating point numbers, wherein the third plurality of floating point numbers are extracted from a first instance of a shared exponent floating point data type, wherein the fourth plurality of floating point numbers are extracted from a second instance of the shared exponent floating point data type, wherein a third subset of the plurality of hardware components are shared between the first subset of the plurality of hardware components and the second subset of the plurality of hardware components.

In some embodiments, the techniques described herein relate to a method further including: based on the first dot product operation, generating a first scalar output value; and based on the second dot product operation, generating a second scalar output value.

In some embodiments, the techniques described herein relate to a method, where the third subset of the plurality of hardware components includes a two's complement to floating point converter configured to generate the first and second scalar output values.

In some embodiments, the techniques described herein relate to a method, where the third subset of the plurality of hardware components includes a fixed point to two's complement converter.

In some embodiments, the techniques described herein relate to a method, wherein the fixed point to two's complement converter converts values represented in a fixed point representation to a two's complement representation based on sign values of the first plurality of floating point numbers and the second plurality of floating point numbers.

In some embodiments, the techniques described herein relate to a method, where the second subset of the plurality of hardware components includes a significand and sub exponent manager configured to perform a partial reduction operation on the third plurality of floating point numbers and the fourth plurality of floating point numbers.

In some embodiments, the techniques described herein relate to a method, wherein the partial reduction operation is a first partial reduction operation, where the third subset of the plurality of hardware components includes an adder configured to perform a second partial reduction operation on the third plurality of floating point numbers and the fourth plurality of floating point numbers.

In some embodiments, the techniques described herein relate to a method, wherein the second subset of the plurality of hardware components includes a leading zero counter.

In some embodiments, the techniques described herein relate to a method, where the third subset of the plurality of hardware components includes a max exponent selector.

In some embodiments, the techniques described herein relate to a method, wherein the shared exponent floating point data type represents exponents based on a set of shared sub exponent values and a shared main exponent value.

In some embodiments, the techniques described herein relate to a dot product hardware pipeline including: a plurality of hardware components, wherein when the dot product hardware pipeline is configured to operate in a first mode of operation, a first subset of the plurality of hardware components are used to perform a first dot product operation on a first plurality of floating point numbers and a second plurality of floating point numbers, wherein when the dot product hardware pipeline is configured to operate in a second mode of operation, a second subset of the plurality of hardware components are used to perform a second dot product operation on a third plurality of floating point numbers and a fourth plurality of floating point numbers, wherein the third plurality of floating point numbers are extracted from a first instance of a shared exponent floating point data type, wherein the fourth plurality of floating point numbers are extracted from a second instance of the shared exponent floating point data type, wherein a third subset of the plurality of hardware components are shared between the first subset of the plurality of hardware components and the second subset of the plurality of hardware components.

In some embodiments, the techniques described herein relate to a dot product hardware pipeline, wherein, based on the first dot product operation, the dot product hardware pipeline generates a first scalar output value, wherein, based on the second dot product operation, the dot product hardware pipeline generates a second scalar output value.

In some embodiments, the techniques described herein relate to a dot product hardware pipeline, where the third subset of the plurality of hardware components includes a two's complement to floating point converter configured to generate the first and second scalar output values.

In some embodiments, the techniques described herein relate to a dot product hardware pipeline, where the third subset of the plurality of hardware components includes a fixed point to two's complement converter.

In some embodiments, the techniques described herein relate to a dot product hardware pipeline, wherein the fixed point to two's complement converter converts values represented in a fixed point representation to a two's complement representation based on sign values of the first plurality of floating point numbers and the second plurality of floating point numbers.

In some embodiments, the techniques described herein relate to a dot product hardware pipeline, where the second subset of the plurality of hardware components includes a significand and sub exponent manager configured to perform a partial reduction operation on the third plurality of floating point numbers and the fourth plurality of floating point numbers.

In some embodiments, the techniques described herein relate to a dot product hardware pipeline, wherein the partial reduction operation is a first partial reduction operation, where the third subset of the plurality of hardware components includes an adder configured to perform a second partial reduction operation on the third plurality of floating point numbers and the fourth plurality of floating point numbers.

In some embodiments, the techniques described herein relate to a dot product hardware pipeline, wherein the second subset of the plurality of hardware components includes a leading zero counter.

In some embodiments, the techniques described herein relate to a dot product hardware pipeline, where the third subset of the plurality of hardware components includes a max exponent selector.

In some embodiments, the techniques described herein relate to a dot product hardware pipeline, wherein the shared exponent floating point data type represents exponents based on a set of shared sub exponent values and a shared main exponent value.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

In some embodiments, the techniques described herein relate to a dot product hardware pipeline, wherein the partial reduction operation is a first partial reduction operation, where the third subset of the plurality of hardware components includes an adder configured to perform a second partial reduction operation on the third plurality of floating point numbers and the fourth plurality of floating point numbers.

In some embodiments, the techniques described herein relate to a dot product hardware pipeline, wherein the second subset of the plurality of hardware components includes a leading zero counter.

In some embodiments, the techniques described herein relate to a dot product hardware pipeline, where the third subset of the plurality of hardware components includes a max exponent selector.

In some embodiments, the techniques described herein relate to a dot product hardware pipeline, wherein the shared exponent floating point data type represents exponents based on a set of shared sub exponent values and a shared main exponent value. The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method executable by a dot product hardware pipeline comprising a plurality of hardware components, the method comprising:
configuring the dot product hardware pipeline to operate in a first mode of operation;
during the first mode of operation, using a first subset of the plurality of hardware components of the dot product hardware pipeline to perform a first dot product operation on a first plurality of floating point numbers and a second plurality of floating point numbers;
configuring the dot product hardware pipeline to operate in a second mode of operation; and
during the second mode of operation, using a second subset of the plurality of hardware components of the dot product hardware pipeline to perform a second dot product operation on a third plurality of floating point numbers and a fourth plurality of floating point numbers,
wherein the third plurality of floating point numbers are extracted from a first instance of a shared exponent floating point data type, wherein the fourth plurality of floating point numbers are extracted from a second instance of the shared exponent floating point data type,
wherein a third subset of the plurality of hardware components are shared between the first subset of the plurality of hardware components and the second subset of the plurality of hardware components.

2. The method of claim 1 further comprising:
based on the first dot product operation, generating a first scalar output value; and
based on the second dot product operation, generating a second scalar output value.

3. The method of claim 2, where the third subset of the plurality of hardware components comprises a two's complement to floating point converter configured to generate the first and second scalar output values.

4. The method of claim 1, where the third subset of the plurality of hardware components comprises a fixed point to two's complement converter.

5. The method of claim 4, wherein the fixed point to two's complement converter converts values represented in a fixed point representation to a two's complement representation based on sign values of the first plurality of floating point numbers and the second plurality of floating point numbers.

6. The method of claim 1, where the second subset of the plurality of hardware components comprises a significand and sub exponent manager configured to perform a partial reduction operation on the third plurality of floating point numbers and the fourth plurality of floating point numbers.

7. The method of claim 6, wherein the partial reduction operation is a first partial reduction operation, where the third subset of the plurality of hardware components comprises an adder configured to perform a second partial reduction operation on the third plurality of floating point numbers and the fourth plurality of floating point numbers.

8. The method of claim 1, wherein the second subset of the plurality of hardware components comprises a leading zero counter.

9. The method of claim 1, where the third subset of the plurality of hardware components comprises a max exponent selector.

10. The method of claim 1, wherein the shared exponent floating point data type represents exponents based on a set of shared sub exponent values and a shared main exponent value.

11. A dot product hardware pipeline comprising:
a plurality of hardware components,
wherein when the dot product hardware pipeline is configured to operate in a first mode of operation, a first subset of the plurality of hardware components are used to perform a first dot product operation on a first plurality of floating point numbers and a second plurality of floating point numbers,
wherein when the dot product hardware pipeline is configured to operate in a second mode of operation, a second subset of the plurality of hardware components are used to perform a second dot product operation on a third plurality of floating point numbers and a fourth plurality of floating point numbers,
wherein the third plurality of floating point numbers are extracted from a first instance of a shared exponent floating point data type, wherein the fourth plurality of floating point numbers are extracted from a second instance of the shared exponent floating point data type,
wherein a third subset of the plurality of hardware components are shared between the first subset of the plurality of hardware components and the second subset of the plurality of hardware components.

12. The dot product hardware pipeline of claim 11, wherein, based on the first dot product operation, the dot product hardware pipeline generates a first scalar output value,
wherein, based on the second dot product operation, the dot product hardware pipeline generates a second scalar output value.

13. The dot product hardware pipeline of claim 12, where the third subset of the plurality of hardware components comprises a two's complement to floating point converter configured to generate the first and second scalar output values.

14. The dot product hardware pipeline of claim 11, where the third subset of the plurality of hardware components comprises a fixed point to two's complement converter.

15. The dot product hardware pipeline of claim 14, wherein the fixed point to two's complement converter converts values represented in a fixed point representation to a two's complement representation based on sign values of the first plurality of floating point numbers and the second plurality of floating point numbers.

16. The dot product hardware pipeline of claim 11, where the second subset of the plurality of hardware components comprises a significand and sub exponent manager configured to perform a partial reduction operation on the third plurality of floating point numbers and the fourth plurality of floating point numbers.

17. The dot product hardware pipeline of claim 16, wherein the partial reduction operation is a first partial reduction operation, where the third subset of the plurality of hardware components comprises an adder configured to perform a second partial reduction operation on the third plurality of floating point numbers and the fourth plurality of floating point numbers.

18. The dot product hardware pipeline of claim 11, wherein the second subset of the plurality of hardware components comprises a leading zero counter.

19. The dot product hardware pipeline of claim 11, where the third subset of the plurality of hardware components comprises a max exponent selector.

20. The dot product hardware pipeline of claim 11, wherein the shared exponent floating point data type represents exponents based on a set of shared sub exponent values and a shared main exponent value.
